(19) United States
(12) Patent Application Publication
(10) Pub. No.: US 2022/0366738 A1
(43) Pub. Date: Nov. 17, 2022

(54) METHOD AND APPARATUS FOR AUTOMATED IMPACT RECORDING, ACCESS CONTROL, GEO-FENCING, AND OPERATOR COMPLIANCE IN INDUSTRIAL LIFT TRUCKS

(71) Applicant: STOCKED ROBOTICS, INC., Austin, TX (US)

(72) Inventors: Kuldipsingh Pabla, San Jose, CA (US); Saurav Agarwal, Austin, TX (US)

(73) Assignee: STOCKED ROBOTICS, INC., Austin, TX (US)

(21) Appl. No.: 17/319,159

(22) Filed: May 13, 2021

(51) Int. Cl. G07C 5/08; G06N 5/02

(52) U.S. Cl. CPC G07C 5/0841; G06N 5/02

(57) ABSTRACT

A system for controlling a vehicle comprising a vehicle condition monitor coupled to the vehicle and configured to generate a plurality of vehicle operational data signals and a predictive behavior system coupled to the vehicle condition monitor and configured to generate vehicle control data as a function of the vehicle operational data signals and operator historical data.

### TECHNICAL FIELD

The present disclosure relates generally to automated control of vehicles, and more specifically to a method and apparatus for automated impact recording, access control, geo-fencing, and operator compliance for industrial lift trucks.

### BACKGROUND OF THE INVENTION

The US Occupational Safety and Health Administration (OSHA) estimates that there are approximately 96,000 industrial truck accidents every year in the United States. These accidents may often lead to death or serious bodily injury, and also involve equipment and product damage in warehouses, distribution centers, manufacturing plants, and other such facilities.

OSHA requires employers to provide their employees with working conditions that are free of known dangers. The Occupational Safety and Health Act created OSHA, which sets and enforces protective workplace safety and health standards.

### SUMMARY OF THE INVENTION

A system for controlling a vehicle is disclosed that includes a vehicle condition monitor coupled to the vehicle and configured to generate a plurality of vehicle operational data signals, such as a deceleration signal that is indicative of an impact. A predictive behavior system is coupled to the vehicle condition monitor and is configured to generate vehicle control data as a function of the vehicle operational data signals and operator historical data, such as to generate an incident report that includes the operator historical data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for providing automated impact recording, access control, geo-fencing, and operator compliance in industrial lift trucks, in accordance with an example embodiment of the present disclosure;

FIG. 2 is a diagram of an algorithm for providing automated impact recording, access control, geo-fencing, and operator compliance in industrial lift trucks, in accordance with an example embodiment of the present disclosure;

FIG. 3 is a diagram of an algorithm for predicting operator behavior, in accordance with an example embodiment of the present disclosure;

FIG. 4 is a diagram of an algorithm for predicting vehicle maintenance, in accordance with an example embodiment of the present disclosure; and

FIG. 5 is a diagram of an algorithm for providing vehicle access control, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

OSHA often mandates certain compliance requirements for safety regulations that it promulgates, such as the need to submit incident reports and to track specific information. It is not easy for owners and operators of warehouses to understand those regulations and to provide all the information that may be required. Lack of information can lead to heavy penalties.

Some of the problems currently faced by warehouse administrators may include:

(1) Inspection reports are often maintained in paper format, which is difficult to maintain in a warehouse environment. The paper documents can be damaged, destroyed or otherwise obscured, resulting in a loss of authenticity of records and potential fines.

(2) It can be difficult to determine the cause of an accident, because there is usually limited information available about what happened just before an incident and immediately after the incident.

(3) It may not always be possible to identify an operator involved in an incident. Specifically, an incident may have been caused by an operator who was not certified to operate a certain class of vehicles, and that operator might not identify themselves.

(4) An operator might also be operating a vehicle that did not pass inspection or which is past due for an inspection, which could cause the vehicle to be dangerous to operate or not fit for operation. However, whether that contributed to a specific accident might not be easy to determine.

The present disclosure is directed to a compliance system and method that provides automated incidence recording, access control, automated inspection recording and other related functions. The system and method can assist operators to lower accident rates by ensuring that safety inspections are performed for vehicles, by tracking operator behavior to identify operators that need training, and to provide ways to improve operator behavior. Further, the present disclosure captures data that objectively defines driver behavior and vehicle maintenance, which can be wirelessly transmitted to a remote computer system for analysis and to help modify the behavior of the industrial truck and driver in real-time.

In one example embodiment, a vehicle-mounted touch screen with simple and intuitive user interface controls can be provided. An authorized administrator can assign (or reassign) a touch screen to a vehicle.

In another example embodiment, the present disclosure provides multiple ways to authenticate or identify an operator, which can be used individually or in combination for greater accuracy in operator identification. For example, an operator can be prompted to enter a Personal Identification Number or PIN prior to unlocking the vehicle for use, a QR code or other suitable graphic identifier can be prior to unlocking the vehicle for use, and RFID badge can be read prior to unlocking the vehicle for use, facial recognition can be used to identify an operator prior to unlocking the vehicle for use, biometric data (such as fingerprint or voice recognition) can be read prior to unlocking the vehicle for use, or other suitable identification processes or combinations of identification processes can be used.

In another example embodiment, the present disclosure includes recording impact incidences and an associated classification or force metric, generates an alert to administrators for immediate review, and can generate a report with recorded information to assist administrators with preparing incident reports and to better understand the cause of an incident. Some of the data that is recorded can includes a time stamp, the operator name and identifier, the vehicle identifier, operator image data from the time of the incident and other suitable data, video recordings from the vehicle and surrounding video monitors, including video recordings from before and after an incident occurs, and force data related to the intensity of an impact, such as in multiples of g (gravity) forces or in other suitable metrics.

The present disclosure can use vehicle sensor data to detect incidents and to generate incident reports resulting from sudden or hard application of the brakes, and impact or near miss involving a pedestrian, an impact or near miss involving infrastructure or objects, violation of access restrictions and access control (automatic enabling/disabling of a vehicle in various scenarios) to prevent vehicle operation (such as due to inspection failure, an unauthorized operator, or other conditions, and can also be used to lock the vehicle at the end of a shift) or to automatically re-enable operation (such as to unlock on successful authorization and successful passing of inspection).

The present disclosure also allows Global Positioning Satellite (GPS) or other location data for a vehicle to be used to control the vehicle and to create incidence report content. The GPS location data can also be used for tracking the vehicle location.

In order to reduce the amount of data that is generated that is not required if an incident does not occur, the above data can be stored for a predetermined period of time (such as one hour), in addition to engine data such as fluid levels, maintenance requirements, error codes from the vehicle or other suitable data.

The present disclosure can also assist the operator with performing predefined inspection checklists, such as an OSHA checklist.

The present disclosure also allows for predicting operator behavior by using incident records and associated data to predict operator driving behavior. It can alert administration of a bad behavior so that early preventive actions, such as training, can be taken.

The present disclosure further provides for predicting maintenance scheduling. In one example embodiment, data such as vehicle systems data, inspection reports and incidence reports can be used to predict and recommend maintenance, a retirement schedule for a vehicle, or other maintenance data.

The present disclosure also provides readily available reports for auditing. The reports can be automatically generated and stored, to assist administration during audits.

Offline reporting capability is also provided for facilities that have poor connectivity or no connectivity in certain parts of the facility. The system synchronize data from different sources and assemble it into a single incident report, as needed.

The present disclosure also provides geo-fencing capabilities, such as using vehicle to infrastructure sensors, Bluetooth low energy (BLE) sensors or other suitable devices. In one example embodiment, the system can alert an operator when a sensor is detected, can lock a vehicle from moving into restricted areas or can perform other suitable functions. Using these sensors allows speed limits to be dynamically controlled as a function of zone, allows zones to be defined as restricted areas and so forth.

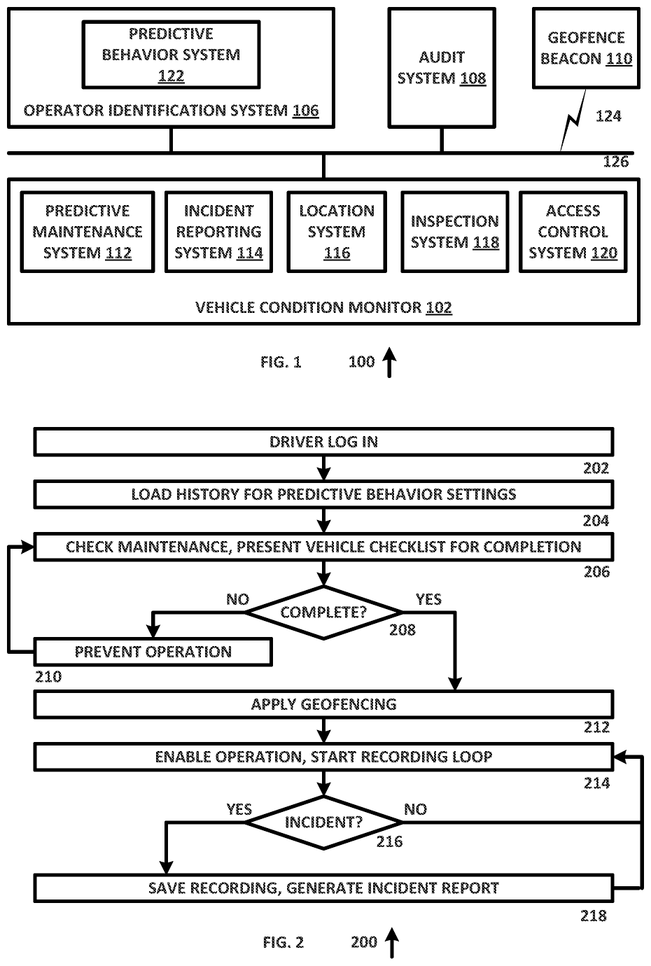

FIG. 1 is a diagram of a system 100 for providing automated impact recording, access control, geo-fencing, and operator compliance in industrial lift trucks, in accordance with an example embodiment of the present disclosure. System 100 includes vehicle condition monitor 102, which further includes maintenance system 112, incident reporting system 114, location system 116, inspection system 118 and access control system 120, operator identification system 106 which further includes predictive behavior system 122, audit system 108, geo-fence sensor 110, wireless network 124 and enterprise network 126, each of which can be implemented in hardware or a suitable combination of hardware and software.

In one example embodiment, system 100 can be retrofitted onto a vehicle with the installation of vehicle monitors, video cameras or other suitable equipment, which can require specific modifications to be made to system 100. In this example embodiment, a vehicle may have an engine monitor system but no video monitors, sensor monitors or other suitable equipment as shown in system 100. System 100 allows a vehicle to be augmented with the additional equipment and to be configured as needed to interact with other system components, such as by including one or more user-configurable system component settings to allow the system components to operate as an ordered combination, or in other suitable manners.

Vehicle condition monitor 102 can be implemented as one or more algorithms that are stored in a data memory device of a processor and that are loaded onto the processor to cause it to monitor data from one or more vehicle system components, to analyze the data to determine whether a condition exceeds a predetermined criterion, to monitor multiple vehicle data streams to determine whether the multiple data streams are exceeding predetermined criteria for the multiple streams and to perform other suitable functions. In one example embodiment, vehicle condition monitor 102 can monitor speed data and braking data, and can determine whether speed is increasing when braking is applied, which can indicate the existence of a slippery surface on a downward slope, which can contribute to an unsafe condition. Vehicle condition monitor 102 can then use GPS data to identify the location of the slippery surface and can generate an incident report to request corrective action. Vehicle condition monitor 102 can perform other suitable comparative functions, including but not limited to:

1) monitoring speed data signals and location data signals of multiple vehicles to identify potential collision risks;

2) monitoring speed data signals and direction data signals to identify when a vehicle is being turned while moving too fast;

3) monitoring speed data signals and weather data signals to determine whether a vehicle is being operated in an unsafe manner when there is ice or snow on a surface; and

4) monitoring speed data signals and location data signals to determine whether a driver should be alerted to reduce speed as the vehicle approaches an area with a slippery surface or slow speed limit.

In addition, vehicle condition monitor 102 can utilize data from other system component of system 100, and can process multiple data streams from those different systems to identify unsafe operating conditions, unsafe operator behavior, or other conditions. The data monitored and generated by vehicle condition monitor 102 can also be used to generate incident reports, corrective action reports and other suitable data.

Predictive maintenance system 112 can be implemented as one or more algorithms that are stored in a data memory device of a processor and that are loaded onto the processor to cause it to identify one or more predictive maintenance alerts or instructions, as a function of multiple data sources. In one example embodiment, a vehicle may be used for an average of 10 miles a day by a first operator and 20 miles a day by a second operator. If a scheduled maintenance is due in 15 miles, predictive maintenance system 112 can generate a notice to the second operator that the vehicle should be taken in for scheduled maintenance if the second operator takes the vehicle from a pool, whereas if the first operator takes the vehicle from the pool then the notice can be generated at the end of the day. Likewise, predictive maintenance system 112 can interface with access control system 120 to prevent the second operator from taking the vehicle, can generate an alert through inspection reporting system 118 or can perform other suitable functions in an ordered combination with the other system components of system 100, as further discussed herein.

Incident reporting system 114 can be implemented as one or more algorithms that are stored in a data memory device of a processor and that are loaded onto the processor to cause it to generate an incident report having predetermined data fields. In one example embodiment, incident reporting system 114 can operate as an ordered combination with the other system components of system 100 to generate operator identification data, vehicle identification data, vehicle condition data, operating condition data, image data of the operator and surroundings and other suitable data that can help to analyze an accident or other operational incident.

Location system 116 can be implemented as one or more algorithms that are stored in a data memory device of a processor and that are loaded onto the processor to cause it to generate location data for a vehicle, location data for objects, location data for unsafe conditions or other suitable location data. In one example embodiment, location system 116 can receive location data from geo-fence sensor 110, where a plurality of sensors are used in a facility to alert an operator of areas that are off limits, or areas that are safe to use or for other suitable purposes. Location system 116 can operate as an ordered combination with the other system components of system 100, as discussed further herein.

Inspection system 118 can be implemented as one or more algorithms that are stored in a data memory device of a processor and that are loaded onto the processor to cause it to determine whether a vehicle inspection is required or is going to be required during a shift. In one example embodiment, inspection system 118 can receive driver data and vehicle data and can determine whether a driver is likely to exceed a remaining number of miles, time period or other metrics during that driver's shift, such as based on historical data of the driver, historical data for the type of vehicle, historical data for the type of work to be performed or in other suitable manners. Inspection system 118 can also generate a user interface control that requires the driver to enter an estimated length of time, mileage or other usage metric for a shift, and can generate an instruction to take the vehicle to maintenance if the usage metric exceeds and allowable usage metric prior to an inspection deadline. Inspection system 118 can function as an ordered combination in conjunction with access control system 120 or other system components of system 100, as discussed further herein.

Access control system 120 can be implemented as one or more algorithms that are stored in a data memory device of a processor and that are loaded onto the processor to cause it to control access to a vehicle by an operator, to control access to a physical location with a vehicle, or to otherwise control access associated with the use of a vehicle. In one example embodiment, a driver identifier can be used to determine whether a driver is authorized to operate a vehicle, whether the driver requires training before they can operate the vehicle, or whether other driver identifier parameters indicate that driver access to the vehicle should be controlled or prohibited. In another example embodiment, access control system 120 can determine whether a vehicle is authorized to enter an area based on driver identification data, vehicle type data or other suitable data, whether the area is temporarily off limits to some or all vehicles or whether other restrictions on vehicle operation are to be applied. Access control system 120 can function as an ordered combination in conjunction with location system 116 or other system components of system 100, as discussed further herein.

Operator identification system 106 can be implemented as one or more algorithms that are stored in a data memory device of a processor and that are loaded onto the processor to cause it to identify an operator. For example, an operator can be prompted to enter a PIN prior to unlocking the vehicle for use, a QR code or other suitable graphic identifier can be prior to unlocking the vehicle for use, and RFID badge can be read prior to unlocking the vehicle for use, facial recognition can be used to identify an operator prior to unlocking the vehicle for use, biometric data (such as fingerprint or voice recognition) can be read prior to unlocking the vehicle for use, or other suitable identification processes or combinations of identification processes can be used. Operator identification system 106 can function as an ordered combination in conjunction with location system 116 or other system components of system 100, as discussed further herein.

Predictive behavior system 122 can be implemented as one or more algorithms that are stored in a data memory device of a processor and that are loaded onto the processor to cause it to generate vehicle controls, driver interface controls or other suitable controls as a function of a driver profile. In one example embodiment, a driver can provide a driver identifier that can be used to determine whether the driver has a history of speeding, a history of impacts with objects or other suitable driver history data, where predictive behavior system 122 modifies the operation of the vehicle to accommodate for the driver history data, such as by applying a limit to a speed controller, by generating a warning when an object is closer than a predetermined distance, or in other suitable manners. In this manner, predictive behavior system 122 can modify the operation of vehicle controls as a function of driver profile data. Predictive behavior system 122 can function as an ordered combination in conjunction with location system 116 or other system components of system 100, as discussed further herein.

Audit system 108 can be implemented as one or more algorithms that are stored in a data memory device of a processor and that are loaded onto the processor to cause it to perform periodic audits, to generate audit reports and to perform other suitable functions. In one example embodiment, audit system 108 can receive audit requirements data and can read and store vehicle data as a function of the audit requirements data, such as to record driver behavior (such as accelerating, turning and braking performance), vehicle operational parameters (such as tire pressure or impact deceleration) and other suitable data. Audit system 108 can function as an ordered combination in conjunction with location system 116 or other system components of system 100, as discussed further herein.

Geo-fence sensor 110 can be implemented as one or more algorithms that are stored in a data memory device of a processor and that are loaded onto the processor to cause it to generate a sensor signal that identifies the location. In one example embodiment, the sensor signal can include encoded data that identifies allowable vehicles or personnel who are permitted to enter an area, can be used to exclude predetermined vehicles or persons from an area, can provide operational data for an area (such as to indicate that the area is wet or has loose objects due to construction or other activities) or other suitable data. Geo-fence sensor 110 can also be used as an ordered combination in conjunction with location system 116 or other system components of system 100, such as to allow location system 116 to cross-reference a sensor identifier with map data or as otherwise discussed further herein.

Wireless network 124 can be implemented as one or more algorithms that are stored in a data memory device of a processor and that are loaded onto the processor to cause it to provide data networking, sensor identification and other suitable functions. Wireless network 124 can function as an ordered combination in conjunction with location system 116 or other system components of system 100, as discussed further herein.

Enterprise network 126 can be implemented as one or more algorithms that are stored in a data memory device of a processor and that are loaded onto the processor to cause it to provide data networking or other suitable functions. Enterprise network 126 can function as an ordered combination in conjunction with location system 116 or other system components of system 100, as discussed further herein.

In operation, system 100 allows a vehicle to be controlled to assist an operator, to provide operator controls, to limit vehicle functions or to perform other suitable functions.

FIG. 2 is a diagram of an algorithm 200 for providing automated impact recording, access control, geo-fencing, and operator compliance in industrial lift trucks, in accordance with an example embodiment of the present disclosure. Algorithm 200 can be implemented in hardware or a suitable combination of hardware and software.

Algorithm 200 begins at 202, where it is determined whether a driver has properly logged in. In one example embodiment, multiple factor authentication can be used, such as to prompt a driver to enter a code and performing biometric authentication, or in other suitable manners. The algorithm then proceeds to 204.

At 204, operator history data is loaded for analysis of predictive behavior settings. In one example embodiment, the operator history data can be used to set vehicle operational control limits, to generate operator assistance alerts, to restrict vehicle operations or access, and to perform other suitable functions. The algorithm then proceeds to 204.

At 206, vehicle maintenance data is processed to determine whether the vehicle can be allowed to operate, and a vehicle safety checklist can be generated and provided to the operator for completion. In one example embodiment, the vehicle safety checklist can be generated based on manufacturer's recommendations, vehicle history data or other suitable data. For example, if the vehicle is approaching a tire wear mileage metric, the operator can be asked to measure a tread depth and to enter the measured tread depth before the vehicle is allowed to operate. Likewise, other suitable vehicle characteristics that cannot be automatically measured can be determined by the operator and entered for use in a subsequent audit or for other suitable purposes. The algorithm then proceeds to 204.

At 208, it is determined whether required maintenance has been completed. In one example embodiment, the required maintenance data can be provided by a certified maintenance service provider or other suitable personnel. If it is determined that the required maintenance has been completed, the algorithm proceeds to 212, otherwise the algorithm proceeds to 210.

At 210, operation of the vehicle is prevented. In one example embodiment, the vehicle can be allowed to travel to a maintenance facility, and can be restricted from deviating from a predetermined route, an alert can be generated if an operator is not taking the vehicle to a maintenance facility, or other suitable processes can also or alternatively be used. The algorithm then returns to 206.

At 212, geo-fencing is applied. In one example embodiment, geo-fencing can be based on geo-fencing sensor signals, GPS location data or other suitable data, and can be used to generate an alert to a driver not to enter an area, to generate an incident report if a driver enters a prohibited area or for other suitable purposes. The algorithm then proceeds to 214.

At 214, operation of the vehicle is enabled and a recording loop is started. In one example embodiment, the recording loop can include image data, video data, vehicle speed and braking log data, vehicle acceleration and deceleration data and other suitable data. The algorithm then proceeds to 216.

At 216, it is determined whether an incident has occurred. If it is determined that an incident has not occurred, the algorithm proceeds to 218, otherwise the algorithm returns to 214. The algorithm then proceeds to 204.

At 218, the looped recording data is saved and an incident report is generated. In one example embodiment, the incident report can include the vehicle data (image data, video data, vehicle speed and braking log data, vehicle acceleration and deceleration data) and other suitable data. The algorithm then returns to 214.

In operation, algorithm 200 can be used to provide automated impact recording, access control, geo-fencing, and operator compliance in industrial lift trucks, as well as other suitable functions as discussed and disclosed herein. Although algorithm 200 has been shown and described as a flow chart, a person of skill in the art would recognize that algorithm 200 can be implemented using object-oriented programming techniques, a state diagram, a ladder diagram or in other suitable manners.

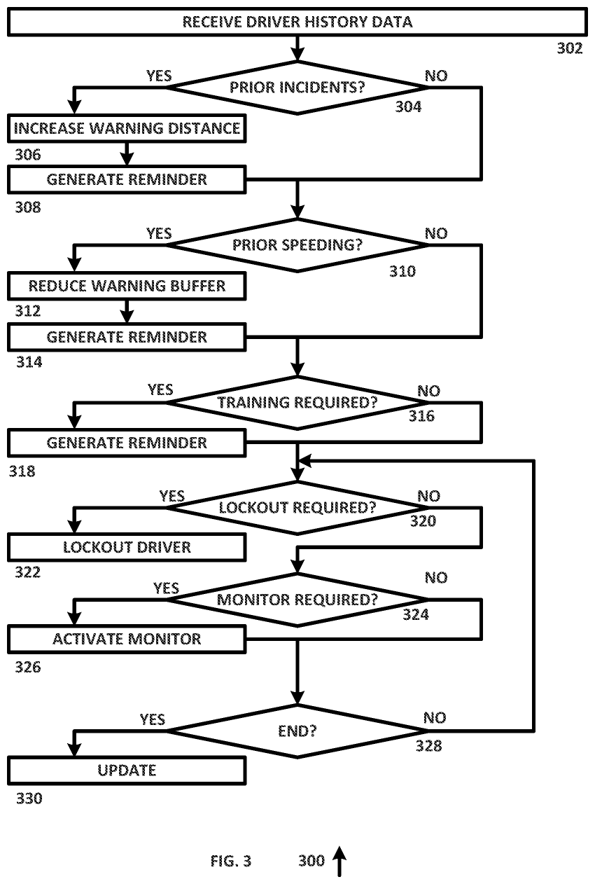

FIG. 3 is a diagram of an algorithm 300 for predicting operator behavior, in accordance with an example embodiment of the present disclosure. Algorithm 300 can be implemented in hardware or a suitable combination of hardware and software.

Algorithm 300 begins at 302, where driver history data is received, such as from a driver authentication server or in other suitable manners. In one example embodiment, the driver history data can be provided after a driver has entered a unique identified, has provided a security device, has provided biometric data or has otherwise been authenticated, so as to prevent driver history data from being provided to unauthorized third parties. The algorithm then proceeds to 304.

At 304, it is determined whether the driver has had prior incidents. In one example embodiment, a prior incident can include incidents other than accidents, such as exceeding an operational speed limit, driving with a load that is elevated at too high of a height, driving with a load that is too heavy, taking a turn at too fast a speed, stopping too close to an obstacle or person, or other suitable incidents. Likewise, the prior incident can include damage-causing accidents, personal injury accidents or other more serious accidents, or other suitable data. If it is determined that the driver has not had prior incidents, the algorithm proceed to 310, otherwise the algorithm proceeds to 306.

At 306, a warning buffer is increased. In one example embodiment, the warning buffer can be a distance to an obstacle, person, building, vehicle or other object at which a warning is played to the driver, a tactile alert is provided, the vehicle horn is sounded, the brakes are automatically applied or other suitable vehicle controls or indications are executed. The algorithm then proceeds to 308.

At 308, a reminder is generated for the driver. In one example embodiment, a display or audible reminder can be generated that reminds the driver that a warning buffer has been increased, that the driver should ensure that an operational parameter is not exceeded, or other suitable reminders can be generated. The algorithm then proceeds to 310.

At 310, it is determined whether the driver has prior speeding incidents. In one example embodiment, the frequency, amount of speeding, dates of speeding incidents and other suitable data can be obtained, such as from a server. The algorithm then proceeds to 312.

At 312, a warning buffer is reduced. In one example embodiment, the warning buffer can be a speed in excess of a speed limit at which a warning is played to the driver, a tactile alert is provided, the vehicle horn is sounded, the brakes are automatically applied or other suitable vehicle controls or indications are executed. The algorithm then proceeds to 314.

At 314, a reminder is generated for the driver. In one example embodiment, a display or audible reminder can be generated that reminds the driver that a warning buffer has been increased, that the driver should ensure that the speed limit should not be exceeded, or other suitable reminders can be generated. The algorithm then proceeds to 316.

At 316, it is determined whether training is required. If training is not required, the algorithm proceeds to 320, otherwise the algorithm proceeds to 318.

At 318, a training reminder is generated. In one example embodiment, the reminder can be displayed or audibly provided to the driver, a notice can be provided to a supervisor or other suitable training reminders is generated. The algorithm then proceeds to 320.

At 320, it is determined whether a lockout is required. If it is determined that a lockout is not required, the algorithm proceeds to 324, otherwise the algorithm proceeds to 322.

At 322, the driver is locked out from operating the vehicle. In one example embodiment, the driver can be notified of the requirements for removing the lockout, the reason for the lockout or other suitable information can be provided. Likewise, a test can be provided, a code can be requested, a third party can be contacted or other suitable functions can be performed to determine whether the lockout can be reversed. The algorithm then proceeds to 324.

At 324, it is determined whether a monitor is required. In one example embodiment, the monitor can receive real-time video feed, alerts or other suitable data, such as to allow the monitor to remotely oversee driver activities and vehicle operations. In another example embodiment, a monitor can be alerted when a vehicle has exceeded a speed limit, when the vehicle has experienced a deceleration consistent with a collision, when a request is received from a vehicle or a driver for real time monitoring or in other suitable manners. The algorithm then proceeds to 326.

At 326, the monitor is activated, such as by generating an alert, transmitting a video feed or in other suitable manners. The algorithm then proceeds to 328.

At 328, it is determined whether the driver access to the vehicle has ended, such as when a driver logs off after parking the vehicle and removing the keys or in other suitable manners. If it is determined that the driver has not completed use of the vehicle, the algorithm returns to 320, otherwise the algorithm proceeds to 330.

At 330, the driver history data, vehicle history data and other suitable data is updated. In one example embodiment, the non-occurrence of any incidents can be tracked to determine whether a driver is maintaining a safe operating record, such as after a driver has received training, after a driver has been involved in an incident or in other suitable manners. Vehicle history data and other suitable data can also or alternatively be updated.

In operation, algorithm 300 can be used to predict operator behavior, as well as other suitable functions as discussed and disclosed herein. Although algorithm 300 has been shown and described as a flow chart, a person of skill in the art would recognize that algorithm 300 can be implemented using object-oriented programming techniques, a state diagram, a ladder diagram or in other suitable manners.

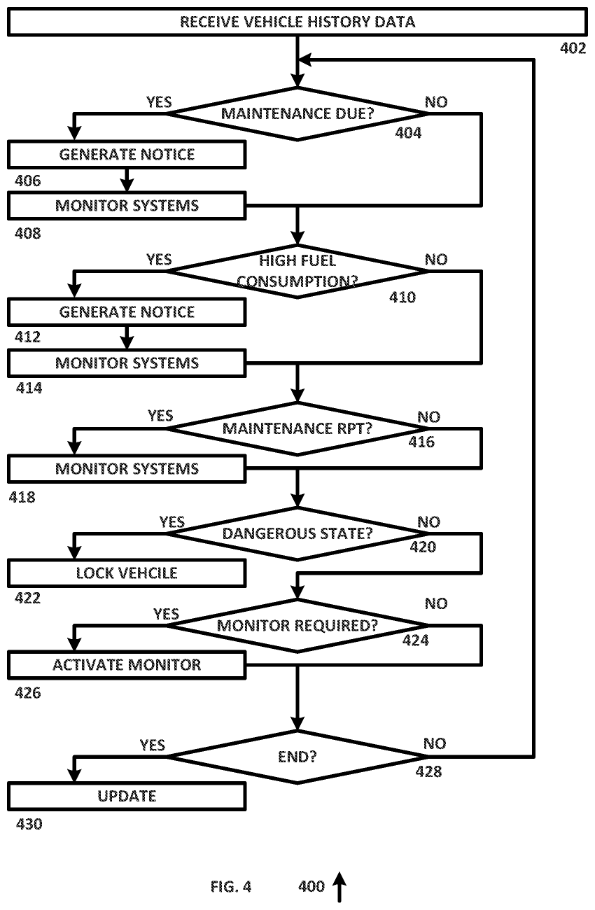

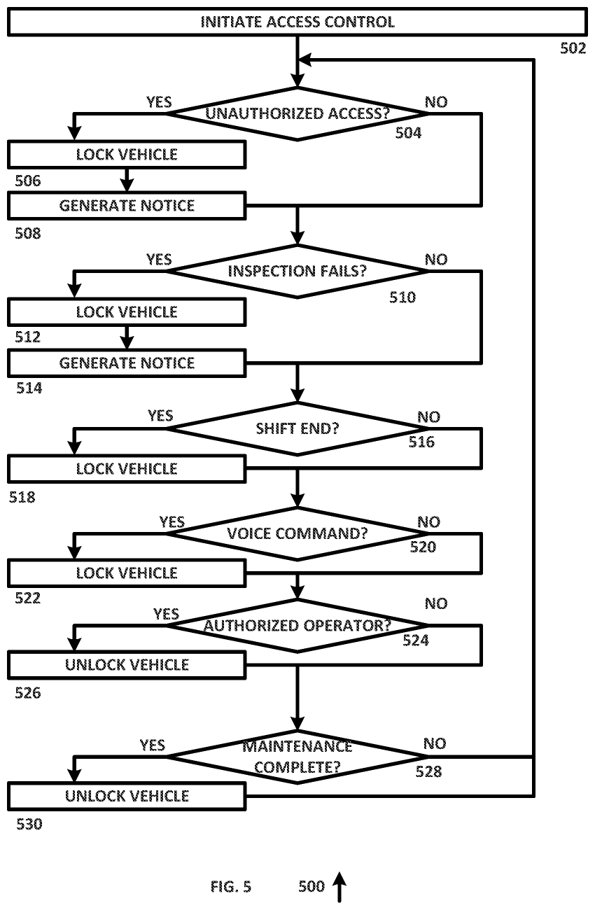

FIG. 4 is a diagram of an algorithm 400 for predicting vehicle maintenance, in accordance with an example embodiment of the present disclosure. Algorithm 400 can be implemented in hardware or a suitable combination of hardware and software.

Algorithm 400 begins at 402, where vehicle history data is received. In one example embodiment, the vehicle history data can include maintenance schedule data, operational history data (such as number of braking incidents, number of operational incidents), operator inspection reports and other suitable data. The algorithm then proceeds to 404.

At 404, it is determined whether maintenance is due. In one example embodiment, maintenance determinations can be based on scheduled maintenance, inspection report indications, wear and tear as estimated from vehicle operational data, comparisons between historical data for similar vehicles that experienced an in-service failure and historical data for the vehicle or other suitable data. If it is determined that maintenance is not due, the algorithm proceeds to 410, otherwise the algorithm proceeds to 406.

At 406, a notice to an operator, monitor or other suitable party is generated. In one example embodiment, the vehicle can be taken in for maintenance to a maintenance location by an operator. In another example embodiment, the vehicle can be parked at a maintenance facility, and a notice can be generated to the maintenance personnel that maintenance is required, or other suitable processes can also or alternatively be used. The algorithm then proceeds to 408.

At 408, systems are monitored to ensure that maintenance was effective. In one example embodiment, maintenance can result in inadvertent miscalibration, omitted parts or other non-conforming conditions that can be easily corrected if detected early. The algorithm then proceeds to 410.

At 410, it is determined whether a high fuel consumption rate is occurring. In one example embodiment, a fuel consumption history can be monitored to determine whether fuel consumption is trending higher, instantaneous fuel consumption as a function of load or speed can be monitored or other suitable fuel consumption data can be monitored. If it is determined that high fuel consumption is not occurring, the algorithm proceeds to 416, otherwise the algorithm proceeds to 412.

At 412, a notice to an operator, monitor or other suitable party is generated. In one example embodiment, the vehicle can be taken in for maintenance to a maintenance location by an operator. In another example embodiment, the vehicle can be parked at a maintenance facility, and a notice can be generated to the maintenance personnel that maintenance is required, or other suitable processes can also or alternatively be used. The algorithm then proceeds to 414.

At 414, systems are monitored to determine whether the fuel consumption issue has been resolved. The algorithm then proceeds to 416.

At 416, it is determined whether a maintenance report is required. In one example embodiment, a maintenance report can be required when an incident occurs, in response to scheduled maintenance being performed, or at other suitable times. If it is determined that a maintenance report is not required, the algorithm proceeds to 420, otherwise the algorithm proceeds to 418.

At 418, systems are monitored for maintenance report generation, such as to record engine operating parameters that can't be monitored during operation. The algorithm then proceeds to 420.

At 420, it is determined whether the vehicle is in a dangerous state and should be prevented from operating. In one example embodiment, vehicle operational data can indicate that the vehicle should not be allowed to continue operations, such as if oil pressure is lower than a predetermined allowable pressure, if an engine temperature is higher than a predetermined allowable temperature or if other conditions are present. If it is determined that the vehicle is not in a dangerous state, the algorithm proceeds to 424, otherwise the algorithm proceeds to 422.

At 422, the vehicle is locked and prevented from operating. A suitable notice can also be generated to alert the operator, maintenance personnel or other suitable personnel that the vehicle has been disabled and the reason why.

At 424, it is determined whether a monitor is required. In one example embodiment, the monitor can receive real-time video feed, alerts or other suitable data, such as to allow the monitor to remotely oversee driver activities and vehicle operations. In another example embodiment, a monitor can be alerted when a vehicle has exceeded predetermined operating parameters or in other suitable manners. The algorithm then proceeds to 426.

At 426, the monitor is activated, such as by generating an alert, transmitting a video feed or in other suitable manners. The algorithm then proceeds to 428.

At 428, it is determined whether the use of the vehicle has been completed, such as when an operator has parked the vehicle and logged off or in other suitable manners. If it is determined that the use of the vehicle has not completed, the algorithm returns to 404, otherwise the algorithm proceeds to 430.

At 430, vehicle operational data is updated, such as to store braking, acceleration/deceleration, fuel consumption or other suitable operational data for historical analysis uses or other suitable purposes.

In operation, algorithm 400 can be used to predict vehicle maintenance, as well as other suitable functions as discussed and disclosed herein. Although algorithm 400 has been shown and described as a flow chart, a person of skill in the art would recognize that algorithm 400 can be implemented using object-oriented programming techniques, a state diagram, a ladder diagram or in other suitable manners.

FIG. 5 is a diagram of an algorithm 500 for providing vehicle access control, in accordance with an example embodiment of the present disclosure. Algorithm 500 can be implemented in hardware or a suitable combination of hardware and software.

Algorithm 500 begins at 502, where access control is initiated. In one example embodiment, access control can be initiated when a person tries to access the vehicle or in other suitable manners. The algorithm then proceeds to 504.

At 504, it is determined whether an unauthorized access attempt is being made. In one example embodiment, a vehicle can be set to a locked condition as a default, but if it is left unlocked and someone attempts to access the vehicle, the person can be asked to enter a user identifier or other suitable data can be used to determine if the user is authorized. If it is determined that an unauthorized access attempt is not in progress, the algorithm proceeds to 510, otherwise the algorithm proceeds to 506.

At 506, the vehicle is locked. In one example embodiment, the vehicle can be locked by disabling the engine from starting or running, by activating a vehicle lock or in other suitable manners. The algorithm then proceeds to 508.

At 508, a notice is generated. In one example embodiment, the notice can be transmitted to security, saved to a log or other suitable notice data can be generated. The algorithm then proceeds to 510.

At 510, it is determined whether an inspection has failed. In one example embodiment, an inspection may be required to be completed, such as by using an application on a user device, a vehicle user interface control or in other suitable manners. If it is determined that an inspection failure has not occurred, the algorithm proceeds to 516, otherwise the algorithm proceeds to 512.

At 512, the vehicle is locked. In one example embodiment, the vehicle can be locked by disabling the engine from starting or running, by activating a vehicle lock or in other suitable manners. The algorithm then proceeds to 514.

At 514, a notice is generated. In one example embodiment, the notice can be transmitted to security, saved to a log or other suitable notice data can be generated. The algorithm then proceeds to 516.

At 516, it is determined whether a shift end has occurred. In one example embodiment, a vehicle can be automatically locked at the end of a shift or at other suitable times. If it is determined that a shift end has not required, the algorithm proceeds to 520, otherwise the algorithm proceeds to 518.

At 518, the vehicle is locked. In one example embodiment, the vehicle can be locked by disabling the engine from starting or running, by activating a vehicle lock or in other suitable manners. The algorithm then proceeds to 520.

At 520, it is determined whether a voice command to lock the vehicle has been received. In one example embodiment, a voice command can be enabled only for specific users, when specific key words are spoken or in other suitable manners. If it is determined that a voice commands has not been received, the algorithm proceeds to 524, otherwise the algorithm proceeds to 522.

At 522, the vehicle is locked. In one example embodiment, the vehicle can be locked by disabling the engine from starting or running, by activating a vehicle lock or in other suitable manners. The algorithm then proceeds to 524.

At 524, it is determined whether an authorized operator is present. If an authorized operator is not present, the algorithm proceeds to 528, otherwise the algorithm then proceeds to 526.

At 526, the vehicle is unlocked. In one example embodiment, the vehicle can be unlocked by enabling the engine to start or run, by de-activating a vehicle lock or in other suitable manners. The algorithm then proceeds to 528.

At 528, it is determined whether maintenance has been completed. If it is determined that maintenance is not complete, the algorithm returns to 504, otherwise the algorithm proceeds to 530.

At 530, the vehicle is unlocked. In one example embodiment, the vehicle can be unlocked by enabling the engine to start or run, by de-activating a vehicle lock or in other suitable manners. The algorithm then returns to 504.

In operation, algorithm 500 can be used to control vehicle access, as well as other suitable functions as discussed and disclosed herein. Although algorithm 500 has been shown and described as a flow chart, a person of skill in the art would recognize that algorithm 500 can be implemented using object-oriented programming techniques, a state diagram, a ladder diagram or in other suitable manners.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for controlling a vehicle comprising:
a vehicle condition monitor operating on a processor, coupled to one or more data systems of the vehicle, and configured to generate a plurality of vehicle operational data signals; and
a predictive behavior system operating on the processor, coupled to the vehicle condition monitor and configured to generate vehicle control data as a function of the vehicle operational data signals and operator historical data.

2. The system of claim 1 further comprising an audit system operating on the processor, coupled to the vehicle condition monitor and configured to receive a first vehicle operational data signal that identifies an operator, a second vehicle operational data signal that identifies an incident and to generate an audit report that includes the first vehicle operational data signal and the second vehicle operational data signal.

3. The system of claim 1 further comprising an audit system operating on the processor, coupled to the vehicle condition monitor and configured to receive a first vehicle operational data signal from an image data system that identifies an operator, a second vehicle operational data signal from an acceleration monitor that identifies an incident and to generate an audit report that includes the first vehicle operational data signal and the second vehicle operational data signal.

4. The system of claim 1 further comprising an audit system operating on the processor, coupled to the vehicle condition monitor and configured to receive a first vehicle operational data signal from a location system that identifies a location, a second vehicle operational data signal from a geo-fencing system that identifies a boundary violation and to generate an audit report that includes the first vehicle operational data signal and the second vehicle operational data signal.

5. The system of claim 1 wherein the predictive behavior system is configured to generate vehicle control data as a function of the vehicle operational data signals and operator historical data when the vehicle exceeds a speed that is determined as a function of the operator historical data.

6. The system of claim 1 wherein the predictive behavior system is configured to generate vehicle control data as a function of the vehicle operational data signals and operator historical data when the vehicle enters an area that is determined as a function of the operator historical data.

7. The system of claim 1 wherein the predictive behavior system is configured to generate vehicle control data as a function of the vehicle operational data signals and operator historical data when the vehicle exceeds a speed while turning that is determined as a function of the operator historical data.

8. The system of claim 1 wherein the predictive behavior system is configured to generate vehicle control data as a function of the vehicle operational data signals and operator historical data when the vehicle exceeds a braking force that is determined as a function of the operator historical data.

9. The system of claim 1 wherein the predictive behavior system is configured to generate vehicle control data as a function of the vehicle operational data signals and operator historical data when the operator has not completed training as a function of the operator historical data.

10. The system of claim 1 wherein the predictive behavior system is configured to generate vehicle control data as a function of the vehicle operational data signals and geo-fencing data when the vehicle receives a geo-fencing signal that is determined as a function of the operator historical data.

11. A method for controlling a vehicle comprising:
generating a plurality of vehicle operational data signals using a vehicle condition monitor operating on a processor and coupled to one or more data systems of the vehicle; and
generating vehicle control data using a predictive behavior system operating on the processor and coupled to the vehicle condition monitor, as a function of the vehicle operational data signals and operator historical data.

12. The method of claim 11 further comprising:
receiving a first vehicle operational data signal that identifies an operator;
receiving a second vehicle operational data signal that identifies an incident; and
generating an audit report that includes the first vehicle operational data signal and the second vehicle operational data signal.

13. The method of claim 11 further comprising:
receiving a first vehicle operational data signal from an image data system that identifies an operator;
receiving a second vehicle operational data signal from an acceleration monitor that identifies an incident; and
generating an audit report that includes the first vehicle operational data signal and the second vehicle operational data signal.

14. The method of claim 11 further comprising:
receiving a first vehicle operational data signal from a location system that identifies a location;
receiving a second vehicle operational data signal from a geo-fencing system that identifies a boundary violation; and
generating an audit report that includes the first vehicle operational data signal and the second vehicle operational data signal.

15. The method of claim 11 comprising generating vehicle control data when the vehicle exceeds a speed that is determined as a function of the operator historical data.

16. The method of claim 11 comprising generating vehicle control data as a function of the vehicle operational data signals and operator historical data when the vehicle enters an area that is determined as a function of the operator historical data.

17. The method claim 11 comprising generating vehicle control data as a function of the vehicle operational data signals and operator historical data when the vehicle exceeds a speed while turning that is determined as a function of the operator historical data.

18. The method of claim 11 comprising generating vehicle control data as a function of the vehicle operational data signals and operator historical data when the vehicle exceeds a braking force that is determined as a function of the operator historical data.

19. The method of claim 11 comprising generating vehicle control data as a function of the vehicle operational data signals and operator historical data when the operator has not completed training as a function of the operator historical data.

20. The method of claim 11 comprising generating vehicle control data as a function of the vehicle operational data signals and geo-fencing data when the vehicle receives a geo-fencing signal that is determined as a function of the operator historical data.
